(19) United States
(12) Patent Application Publication
(10) Pub. No.: US 2025/0118055 A1
(43) Pub. Date: Apr. 10, 2025

(54) SYSTEMS AND METHODS FOR RENDERING SCENES WITH OBJECT-COMPOSABLE NERFS

(71) Applicant: Embodied Intelligence Inc., Emeryville, CA (US)

(72) Inventors: Nikhil Mishra, Irvine, CA (US); Maximilian Sieb, Berkeley, CA (US); Pieter Abbeel, Emeryville, CA (US); Xi Chen, Emeryville, CA (US)

(21) Appl. No.: 18/895,741

(22) Filed: Sep. 25, 2024

Related U.S. Application Data
(60) Provisional application No. 63/588,020, filed on Oct. 5, 2023.

(51) Int. Cl. G06V 10/774; B25J 9/16; G06T 7/50; G06T 15/10; G06V 10/26; G06V 10/82

(52) U.S. Cl. CPC G06V 10/774; B25J 9/163; G06T 7/50; G06T 15/10; G06V 10/26; G06V 10/82; G06T 2207/20081; G06T 2207/20084; G06V 2201/06

(57) ABSTRACT

Systems, methods, and devices are disclosed herein for generating synthetic data for training computer vision models using an object-composable NeRF model that reduces the sim-to-real gap for perception-based tasks. In one example, a method includes generating a synthetic dataset using the NeRF model, wherein dataset includes both photorealistic renderings and multiple types of 2D and 3D supervision, including depth maps, segmentation masks, and meshes. To generate the dataset, the NeRF model receives as input a real image of a real scene having objects and a background, extracts a feature volume for each object, and renders one or more synthetic scenes using the sampled objects. The method further includes training a perception model based at least in part on the synthetic dataset and controlling a robotic system based at least in part on output from the trained perception model.

### CROSS-REFERENCE TO RELATED APPLICATIONS

This application claims priority to U.S. Provisional Application No. 63/588,020 titled “CLOSING THE VISUAL SIM-TO-REAL GAP WITH OBJECT-COMPOSABLE NERFS”, filed Oct. 5, 2023, which is incorporated herein by reference in its entirety for all purposes.

### TECHNICAL FIELD

Various embodiments of the present technology relate to improving computer vision. More specifically, the technology disclosed herein includes systems and methods for generating synthetic data that reduces the visual sim-to-real gap associated with training computer vision models.

### BACKGROUND

Nearly all applications in robotics require perception of the physical world, and deep learning is the method of choice for most tasks in computer vision. As neural network architectures and training recipes have matured, the availability of training data has become a bottleneck for these methods. Even if a large dataset is available, deployed robotic systems may encounter scenarios that their original training dataset did not prepare them for. Moreover, while some tasks can be supervised via human annotation (e.g., object detection or semantic segmentation), other tasks like depth estimation, shape completion, or optical flow are best supervised in simulation.

However, when models trained in simulation are transferred to the real-world, their performance often degrades because the input distribution has shifted-a well-documented phenomenon known as the sim-to-real gap. Domain randomization is typically used to improve robustness for out-of-distribution inputs: if a model is trained to generalize to different parameters of the simulator (e.g., viewpoint, lighting, or material properties), then it may also generalize to the real world as simply another randomization. However, this requires the training distribution to be both diverse enough to enable generalization, as well as realistic enough that the real world is a plausible sample from this distribution. This can be difficult to achieve in practice, often requiring manual asset creation (i.e., meshes, textures, materials), scene construction, and parameter tuning. Moreover, if a large sim-to-real gap is observed, it can be difficult to know exactly how to improve the simulator, which may require specialized expertise (e.g., graphics for visual tasks) or domain/task-specific tuning.

It is with respect to this general technical environment that aspects of the present technology disclosed herein have been contemplated. Furthermore, although a general environment has been discussed, it should be understood that the examples described herein should not be limited to the general environment identified in the background.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments of the present technology generally relate to improving computer vision. More specifically, the technology disclosed herein includes systems and methods for generating synthetic data for training computer vision models. In a first embodiment, a method includes generating a synthetic dataset using a Neural Radiance Field (NeRF) model. The NeRF model receives as input a real image of a real scene, wherein the real image includes at least a plurality of objects and a background. The NeRF model further extracts, from the real image, a feature volume for each object of the plurality of objects. The NeRF model then renders one or more synthetic scenes of the synthetic dataset, wherein each scene has at least one rendered synthetic object having a pose that differs in other scenes. The method further includes training a perception model based at least in part on the synthetic dataset including the one or more synthetic scenes and controlling a robotic system based at least in part on output from the perception model that has been trained on the synthetic dataset.

In some embodiments, the NeRF model, prior to extracting the feature volume for each object, decomposes the real scene into the plurality of objects and the background. The NeRF model, in some embodiments, generates the feature volume for each object from learned feature vectors specific to each object. The method may further include training the NeRF model with one or more real images and one or more synthetic images. The perception model, in some embodiments, includes at least one of a model instance segmentation model and an amodal instance segmentation model. The perception model, in other embodiments, is a depth estimation model. The robotic system, in some embodiments, includes a robotic arm. Controlling the robotic system, in some embodiments, includes controlling the robotic arm to pick up one or more items from a first location and move the one or more items to a second location. The first location, in some examples, is a bin.

In another embodiment, one or more non-transitory computer-readable storage media have program instructions stored thereon that, when executed by a computing system, direct the computing system to perform operations. The operations include generating a synthetic dataset using a NeRF model. The NeRF model receives as input a real image of a real scene, wherein the real image includes at least a plurality of objects and a background. The NeRF model further extracts, from the real image, a feature volume for each object of the plurality of objects. The NeRF model also renders one or more synthetic scenes of the synthetic dataset, wherein each scene of the synthetic scenes has at least one rendered synthetic object having a pose that differs in other scenes of the one or more synthetic scenes. The operations further include training a perception model based at least in part on the synthetic dataset including the one or more synthetic scenes and controlling a robotic system based at least in part on output from the perception model that has been trained on the synthetic dataset.

In yet another embodiment, a system includes one or more computer-readable storage media, a processing system operatively coupled with the one or more computer-readable storage media, and program instructions stored on the one or more computer-readable storage media. The program instructions, when read and executed by the processing system, direct the processing system to at least generate a synthetic dataset using a NeRF model. The NeRF model receives as input a real image of a real scene, wherein the real image includes at least a plurality of objects and a background. The NeRF model further extracts, from the real image, a feature volume for each object of the plurality of objects. The NeRF model further renders one or more synthetic scenes of the synthetic dataset, wherein each scene of the synthetic scenes includes at least one rendered synthetic object having a pose that differs in other scenes of the one or more synthetic scenes. The program instructions, when read and executed by the processing system, further direct the processing system to train a perception model based at least in part on the synthetic dataset including the one or more synthetic scenes and control a robotic system based at least in part on output from the perception model that has been trained on the synthetic dataset.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates and example of NeRF rendering and robotics environments in which some embodiments of the present technology may be utilized;

FIG. 2 is a flowchart illustrating a series of steps performed in accordance with some embodiments of the present technology;

FIG. 3 illustrates an example of rendering synthetic data with COV-NeRF in accordance with some embodiments of the present technology;

FIG. 4 is a flowchart illustrating a series of steps for rendering scenes with COV-NeRF in accordance with some embodiments of the present technology;

FIG. 5 illustrates an example of scene decomposition as performed by COV-NeRF in accordance with some embodiments of the present technology;

FIG. 6 illustrates an example of a scene generation algorithm that may be implemented in accordance with some embodiments of the present technology; and

FIG. 7 is an example of a computing system in which some embodiments of the present technology may be utilized.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Systems and methods are disclosed herein for completing computer vision-based tasks with a neural rendering method that reduces the sim-to-real gap typically present in simulation-trained models. The rendering method, referred to herein as the Composable-Object-Volume NeRF (COV-NeRF) method, is a neural radiance field (NeRF) method that is both object-centric and scene-generalizable. COV-NeRF extracts objects from real images and composes them into synthetic scenes, generating both photorealistic renderings and many types of 2D and 3D supervision, including depth maps, segmentation masks, and meshes. COV-NeRF, as disclosed herein, matches the visual quality of state-of-the-art NeRF methods while simultaneously enabling rapid and consistent reduction of the sim-to-real gap for many perception-based tasks.

NeRF, more generally, is a method that represents a three-dimensional (3D) scene as a continuous volumetric function using artificial neural networks. A NeRF model takes a 3D coordinate and a viewing direction as input and outputs the color and density at that point in space. By integrating this information along rays passing through the scene, NeRF can render two-dimensional (2D) images from any viewpoint.

Traditional NeRF models typically represent an entire scene as a single neural field, making it difficult to handle scenes with multiple distinct objects. However, an object-composable NeRF model, such as COV-NeRF, breaks down a scene into individual objects or components, each represented by its own NeRF. These object-level NeRFs can then be composed or combined to form a complete scene.

Thus, COV-NeRF is employed to extract neural object representations from disparate source scenes, compose the objects into new scenes in different quantities, poses, and sizes, and render both photorealistic images and the corresponding supervision for many perception tasks. Unlike other deep generative models, COV-NeRF automatically enjoys geometric and semantic consistency between the generated images and labels, giving a repeatable procedure to close the sim-to-real gap: in a loop reminiscent of model-based reinforcement learning, COV-NeRF learns from RGB images of the target domain and can then be used to synthesize training data for downstream tasks.

COV-NeRF has the ability to generate synthetic data targeted to specific real objects based on only a handful of in-the-wild source images. Thus, without artificially imposed consistency constraints, COV-NeRF can generate supervision for a variety of tasks, including depth estimation, object detection, modal and amodal instance segmentation, and shape completion. Moreover, the entire pipeline in which COV-NeRF may be implemented, enables end-to-end task improvement in real-world applications. Such an application in which COV-NeRF may be implemented includes bin-picking applications (i.e., computer-vision-led robotic-based picking of objects from a bin).

Various technical effects may be appreciated from the implementations disclosed herein. Such technical effects include improved modularity, efficiency, scalability, and reusability. Handling objects separately, as described herein, can reduce computational load and complexity as well as enable faster training and rendering times (i.e., efficiency). The implementation of COV-NeRF in computer vision-based tasks also improves scalability by enabling large or complex scenes to be constructed. Moreover, trained models can be reused across different scenes, reducing redundancy. Unlike other deep generative models such as CyCADA, RetinaGAN, and RL-CycleGAN, COV-NeRF automatically enjoys geometric and semantic consistency between the generated images and labels. This repeatable procedure facilitates closing the sim-to-real gap. COV-NeRF learns from RGB images of the target domain, and then can be used to synthesize training data for downstream tasks.

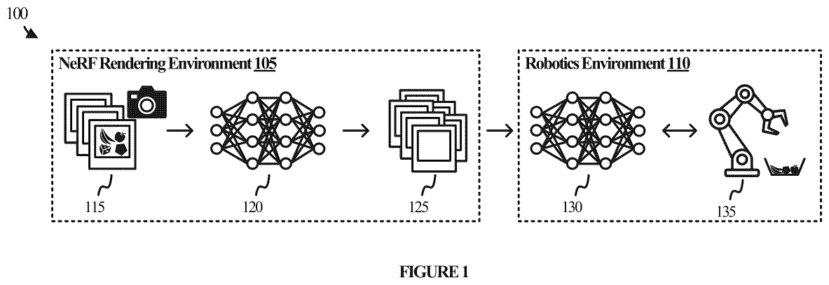

FIG. 1 illustrates environment 100, which is representative of a computing environment in which embodiments of the present technology may be utilized. Environment 100 includes NeRF rendering environment 105 and robotics environment 110. NeRF rendering environment 105 includes real images 115, COV-NeRF model 120, and synthetic images 125. Robotics environment 110 includes perception model 130 and robotic device 135. The environments and elements shown in FIG. 1 are merely exemplary. The COV-NeRF model disclosed herein may be applied to a variety of other environments and used in coordination with a variety of other elements.

In the example of FIG. 1, real images 115 are provided as input to COV-NeRF model 120, via an input layer of COV-NeRF model 120. Real images 115 are real images taken of a source scene by one or more images devices (e.g., cameras). In an exemplary embodiment, real images 115 are taken from various perspectives of the source scene, such as by different cameras in separate locations, or by one camera from multiple locations or perspectives. COV-NeRF model 120 generates synthetic images 125 based at least in part on real images 115. In the example of FIG. 1, COV-NeRF model 120 is a trained COV-NeRF model capable of generating supervision for a variety of tasks including but not limited to depth estimation, object detection, modal and amodal instance segmentation, and shape completion. COV-NeRF model 120 is a NeRF model that is both object-centric and scene-generalizable. COV-NeRF model 120 generates synthetic data targeted to specific real objects based on only a handful of real-world source images. COV-NeRF model 120 learns from RGB images of a target domain and synthesizes training data for downstream tasks.

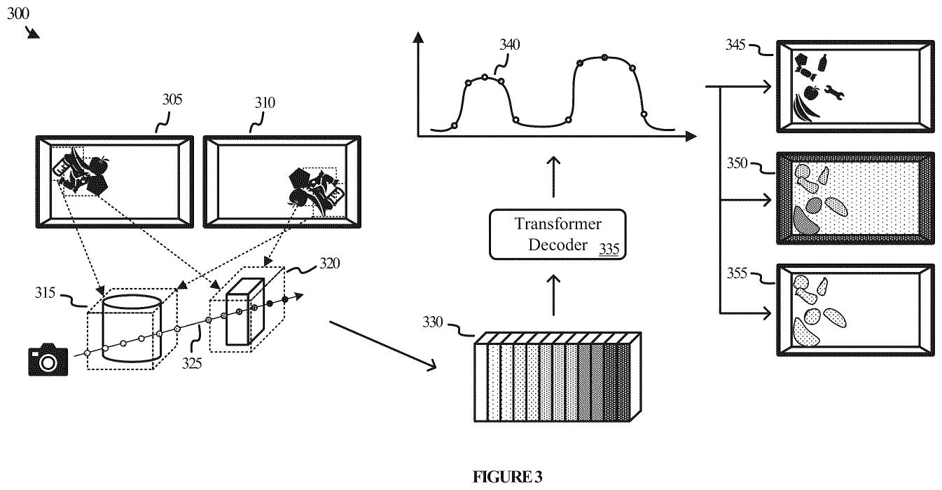

Given the collection of real scenes, real images 115, COV-NeRF model 120 extracts the feature volumes and meshes for each unoccluded object in the images. The meshes are obtained by running an algorithm such as Marching Cubes on the voxel occupancy predictions. Objects (which may or may not have appeared in the same source scene) are then sampled by the model and a physics simulator (e.g., Mujoco) is used to pose the objects in geometrically realistic configurations. COV-NeRF model 120 then renders the composed scenes (i.e., synthetic images 125). The scene generation algorithm is further illustrated in FIGS. 3-6.

Synthetic images 125 are then used to train perception model 130. Perception model 130 may be a depth estimation model, an object detection model, an instance segmentation model (modal or amodal), a shape completion model, or the like. Perception model 130 may be a combination of any two or more of the listed model types. To train perception model 130, synthetic images 125 are provided to perception model 130 as input via an input layer of the model. Perception model 130 is used, at least in part, to guide robotic device 135 to perform a task or a variety of tasks. In some examples, robotic device 135 is configured to pick objects from a bin and move them to a new location. Once perception model 130 is trained, it takes as input images or video captured by one or more imaging devices in the robotic environment where robotic device 135 is stationed. For example, perception model 130 may receive as input one or more images of a bin containing a plurality of objects and use that image data to inform the robotic device's next pick.

Before COV-NeRF model 120 is ready to generate synthetic data from a few source scenes, it is trained. In training, COV-NeRF model 120 learns visual and geometric priors that enable inference when only a few source images (e.g., real images 115) are available. To learn these priors, COV-NeRF model 120 may, in some examples, be trained on a mix of simulated and real data. Simulation may help bootstrap the model's understanding of 3D geometry while real data exposes the model to real textures and materials. By training COV-NeRF model 120 on a mix of simulated and real data, the model can leverage dense geometric supervision when available but is also robust to sim-to-real mismatch.

Training COV-NeRF model 120 thus includes training at least the following losses: (1) view synthesis—the rendered color is trained to match the true color using an L2-loss; (2) depth estimation—the rendered depth is trained to match the ground-truth depth using an L1 loss; (3) instance segmentation-both modal and amodal masks are trained to match the ground-truth masks using cross-entropy loss; and (4) voxel occupancy—the occupancy of each voxel in each object's feature volume is also predicted and supervised.

In practice, one effective method is to pre-train all of the losses (described above) in simulation and then jointly finetune with real data from the target domain. Thus, COV-NeRF model 120 is pre-trained on a small but high-quality simulated dataset that contains the necessary supervision modalities (e.g., pre-trained for 100 epochs on COB-3D-v2).

In the example of FIG. 1, COV-NeRF model 120 runs on one or more computing devices. COV-NeRF model 120 may run on a variety of computing devices, including but not limited to personal computers, servers, and specialized hardware such as GPUs or TPUs. COV-NeRF model 120 may also be executed on mobile devices and/or embedded systems, depending on the computational requirements and available resources. For enhanced performance and scalability, COV-NeRF model 120 may be distributed across multiple devices, such as a cluster of computers or cloud-based servers. In this distributed environment, each device may handle different parts of the model computation or data processing tasks. This approach allows for parallel processing, reducing computation time and improving efficiency. Additionally, COV-NeRF model 120 may take advantage of networked computing systems to offload specific tasks to remote servers or edge devices, optimizing for latency and power consumption.

A computing device running the COV-NeRF model 120 may include various hardware components. These components may include a central processing unit (CPU), a graphics processing unit (GPU), and/or a tensor processing unit (TPU). The device may also include volatile memory such as RAM and non-volatile storage, such as a hard drive or solid-state drive (SSD), to store the model, input data, and results. Additional components may include networking interfaces for distributed computing or cloud-based model execution, along with cooling systems to manage the heat generated by high-performance operations.

Similarly, perception model 130 runs on one or more computing devices, which may be the same computing device or a separate computing device from where COV-NeRF model 120 runs. Perception model 130 may be executed on personal computers, servers, mobile devices, specialized hardware like GPUs or TPUs, or the like. These devices may feature a CPU, GPU, and/or TPU for handling the intensive computations associated with neural networks. Memory components such as RAM may be used for temporary data storage during processing, while non-volatile storage, like SSDs, stores the model, input data, and outputs. Additionally, communication interfaces may enable these devices to connect to networks, allowing the model to be distributed across multiple devices or cloud environments for parallel processing and increased efficiency. In such distributed systems, different devices can process parts of the model or data simultaneously, improving overall performance. Furthermore, cooling systems and power management components may be included.

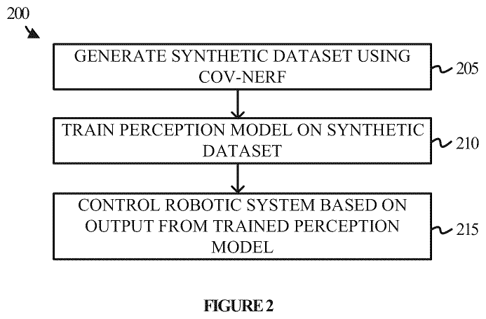

FIG. 2 illustrates process 200. Process 200 is an exemplary operation of rendering synthetic data using a COV-NeRF rendering model, using the synthetic data to train a perception model, and controlling a robotic system based at least in part on output from the trained perception model. Process 200 occurs in environment 100, in some examples. The operations may vary in other examples. The operations of process 200, in some examples, are performed at least in part by COV-NeRF model 120 and/or perception model 130 from FIG. 1.

The operations of process 200 include generating a synthetic dataset using COV-NeRF (step 205). In the example of FIG. 1, COV-NeRF model 120 generates the synthetic dataset, synthetic images 125, based on real images 115. COV-NeRF receives at least one real image of a scene that includes a plurality of objects and a background. The plurality of objects, in some examples, includes only unoccluded objects in the scene (i.e., objects that are not fully or partially blocked from view by other objects). In such examples, other occluded objects may exist in the scene but are not considered a part of the plurality of objects discussed here. COV-NeRF extracts, from the real image(s), at least a feature volume for each of the objects. COV-NeRF may further extract meshes for each object. COV-NeRF further renders one or more synthetic scenes making up the synthetic dataset. The objects in the synthetic scenes may be the same in some examples or may differ between scenes in other examples. Additionally, objects that appear in more than one scene may be presented in poses that differ between the generated scenes.

The operations of process 200 further include training a perception model on the synthetic dataset (step 210). In the example of FIG. 1, perception model 130 is trained based at least in part on synthetic images 125 generated by COV-NeRF model 120. The perception model, in some cases in a machine learning model. The machine learning model may include a deep artificial neural network. During training, the model processes the provided training images and learns to extract relevant features by adjusting internal parameters (e.g., through backpropagation). The model may be given labeled examples (e.g., depth or segmentation predictions generated by COV-NeRF) allowing it to learn the correct associations. As the model processes more images, it refines its ability to recognize patterns and improve accuracy in perception tasks.

The operations of process 200 further include controlling a robotic system based at least in part on output from the trained perception model (step 215). In the example of FIG. 1, perception model 130 plays a role in controlling robotic device 135. Perception model 130 may receive image data from the robotics environment which the model takes as input to produce output (e.g., instance segmentation, depth estimations, etc.) that is used to inform operation of the robotic device. Perception model 130, in some examples, is responsible for controlling operation of robotic device 135. In other examples, perception model 130 provides information to one or more other models that more directly control robotic device 135.

Referring back to step 205, generating the synthetic dataset using the COV-NeRF rendering model is described in greater detail. COV-NeRF accepts as input one or more real images of a scene containing one or more objects and a background. COV-NeRF represents the scene as a collection of objects (o) ({oₖ}ₖ₌₁^{K}) and a background. Each object COV-NeRF identifies in the scene is defined by a frustum, which is discretized into a voxel grid of shape D×H>W (Depth×Height× Width). A learned feature vector is associated with each voxel, resulting in a feature volume V^{(k)} ∈ [symbol] ^{C×D×H×W} where R is a set of real numbers and C is the color of a pixel. The object o^{(k)} is completely specified by its pose p^{(k)} ∈ SO³ and feature volume V^{(k)}.

The feature volumes are computed by projecting the red color, green color, and blue color values (RGB values) from the source views, resulting in an initial feature volume of shape B×3×D×H×W where B is the number of source images. COV-NeRF aggregates information across source views via attention over the B dimension, reducing the volume to C×D×H×W, and then further refines it with a 3D-UNet to produce feature volume V^{(k)}. Each unique object of a scene is associated with and completely specified by its own feature volume V^{(k)} and camera pose, providing COV-NeRF with the flexibility to render synthesized novel views of objects in scenes other than the scene the object was originally captured in.

To render a ray, COV-NeRF gathers the contributions from each object in the scene as well as the background. For the background, COV-NeRF samples points r(tᵢ⁽⁰⁾), t₁⁽⁰⁾, . . . , t_{N}⁽⁰⁾ globally for the entire scene, and predicts σᵢ⁽⁰⁾, cᵢ⁽⁰⁾ using a neural rendering model (e.g., NerFormer) that interpolates visual features from each source view and processes them using a Transformer. If the ray intersects with object o^{(k)}'s frustum, COV-NeRF additionally samples points r(tᵢ^{(k)}, t₁^{(k)}, . . . , t_{N}^{(k)} inside the container. COV-NeRF transforms the points r(tᵢ^{(k)}) and the ray direction d into the object frame, trilinearly interpolates feature vectors vᵢ^{(k)} from V^{(k)}, and uses a Transformer to decode them into σᵢ^{(k)}, cᵢ^{(k)}.

To accumulate these values into Ĉ(r), COV-NeRF sorts {tᵢ^{(k)}}_{i=1,k=0}^{i=N,k=K} and applies equation 1: Ĉ(r)=Σᵢ₌₁^{N} Tᵢσᵢtᵢ where δᵢ=tᵢ₊₁−tᵢ, α₁=1−e^{-δ}^{ᵢ}^{σ}^{ᵢ}, and Tᵢ=e^{-Σ}^{_{j<i}}^{δ}^{ⱼ}^{σ}^{ⱼ}. This natively handles occlusions: even where σᵢ^{(k)} is large, Tᵢ^{(k)} may be small if the ray passes through objects before hitting object oₖ.

The product αᵢ·Tᵢ can be interpreted as the probability that the ray terminates at distance tᵢ. Then the expected distance τ\hat{ }(r) that the ray travels is: τ\hat{ }(r)=Σᵢ₌₁^{N} Tᵢαᵢtᵢ. τ\hat{ }(r) is the distance that the ray travels from the camera center and can be trivially converted into a depth value in the camera frame. COV-NeRF uses this probabilistic analysis, but additionally takes into account the contributions from all objects and background.

COV-NeRF may also leverage this probabilistic interpretation to render instance masks. Typically, each object's mask indicates the pixels where the object is visible (no pixel may be occupied in more than one instance mask). However, in amodal instance segmentation, each mask includes both the object's visible and occluded portions. Amodal instance segmentation is often of interest in robotics, as it allows more direct reasoning about occlusions.

COV-NeRF can render modal and amodal instance masks. Letting M_{u,v}^{k}∈ [0,1] be the probability that pixel (u, v) belongs to object oₖ's modal mask and M̅_{u,v}^{(k)} be the corresponding probability for its amodal mask, then M_{u,v}^{k} is the probability that r_{u,v} terminates inside oₖ: M_{u,v}^{k}=Σᵢ₌₁^{N}Tᵢ^{(k)}αᵢ^{(k)} and M̅_{u,v}^{k} is the probability that r_{u,v} terminates inside o^{(k)} in the absence of other objects: M̅_{u,v}^{k}=Σᵢ₌₁^{N} T̅ᵢ^{(k)}αᵢ^{(k)} where T̅ᵢ^{(k)}=exp(−Σ_{j<i}δⱼ^{(k)}σⱼ^{(k)}).

Regarding equation 1 (above), COV-NeRF uses a differentiable ray-based volumetric rendering procedure to train models for novel view synthesis. Given a collection of source images {I^{(b)}}_{b=1}^{B} of a scene and their corresponding intrinsic/extrinsic matrices, an image I* of the scene as seen from a new viewpoint is rendered. A ray r is parametrized as r(t)=o+t·d, t≥0, where o, d∈ [symbol] ³ are the ray's origin and direction. Each pixel (u, v) ∈ I* corresponds to a particular ray r_{u,v}(t), whose origin and direction depend on the intrinsics and extrinsics. To render a ray, points r(tᵢ), t₁< . . . <t_{N} are sampled along it, and the density σᵢ and radiance cᵢ are determined for each point. These values are accumulated to compute the ray's rendered color, Ĉ(r) (equation 1): Ĉ(r)=Σᵢ₌₁^{N}Tᵢσᵢtᵢ where δᵢ=tᵢ₊₁−tᵢ, αᵢ=1−e^{-δ}^{ᵢ}^{σ}^{ᵢ}, and Tᵢ=e^{-δ}^{_{j<i}}^{σ}^{ⱼ}. The rendered color of pixel (u, v) is Ĉ(r_{u,v}(t)).

Existing NeRF methods predicted σᵢ and cᵢ using fully connected neural networks that took the coordinate r_{u,v}(tᵢ) and the ray direction d as input. However, since these existing methods do not have direct access to the source images during inference, the visual details must be distilled into the network weights via optimization, which prevents them from representing multiple scenes. Moreover, since the networks are trained from scratch for each scene, a large B≈100 is required. In scene-generalizable extensions of these existing methods, the dependence on {I^{(b)}} is made explicit by making these images inputs to the network during rendering, and more powerful architectures (such as 3D-CNNs or Transformers) have been introduced to take advantage of the additional information. Rather than encoding the visual details, the networks learn robust strategies for aggregating information from the source views and can work with only a few source images B≈3.

FIG. 3 illustrates scene generation example 300, which is representative of COV-NeRF's object-centric rendering process in accordance with some embodiments of the present technology. In some examples, the process shown in scene generation example 300 is performed in whole or in part by COV-NeRF model 120 from FIG. 1. Scene generation example 300 includes source image 305, source image 310, feature volume 315, feature volume 320, ray 325, interpolated ray features 330, transformer decoder 335, NeRF density and radiance plot 340, rendered image 345, rendered depth map 350, and rendered segmentation prediction 355. The elements and steps shown in FIG. 3 are merely exemplary. The COV-NeRF model disclosed herein may operate in manners that differ from what is shown in the example of FIG. 3.

Each of source image 305 and source image 310 is taken of the same scene but from different perspectives. Additional source images may be taken in other examples. Visual features from each of the source views are projected into a feature volume—that is, feature volume 315 and feature volume 320. While only two feature volumes are shown in the present example, additional feature volumes may be extracted from the source images. In some examples, a feature volume is extracted for each unoccluded object in the source images. COV-NeRF then performs ray marching through the object-centric feature volumes. For each pixel to be rendered, features are interpolated along the corresponding ray (e.g., ray 325) from each volume that the ray intersects to generate interpolated ray features 330. Transformer decoder 335 then decodes the interpolated ray features into NeRF density and radiance plot 340. The data is then composited into RGB colors, depths, and segmentation masks to create rendered image 345, rendered depth map 350, and rendered segmentation prediction 355.

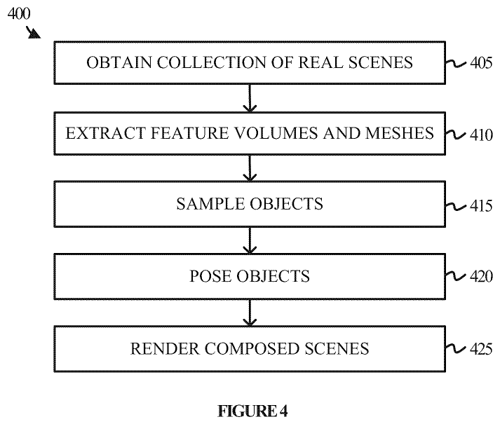

FIG. 4 illustrates process 400. Process 400 is an exemplary operation of rendering synthetic data using a COV-NeRF rendering model. Process 400 reflects scene generation example 300, in some examples. The operations may vary in other examples. The operations of process 400, in some examples, are performed at least in part by COV-NeRF model 120 from FIG. 1.

The operations of process 400 include obtaining a collection of real scenes (step 405). In the example of FIG. 3, the COV-NeRF model takes as input source image 305 and source image 310, which are examples of the real scenes obtained in step 405. The operations of process 400 further include extracting feature volumes and meshes from the collection of real scenes (step 410). In the example of FIG. 3, feature volume 315 and feature volume 320 are extracted from source image 305 and source image 310. In addition to the feature volumes, object meshes are extracted from the image. In some examples, the object meshes are used to help extract the feature volumes by defining the bounds of the detected objects.

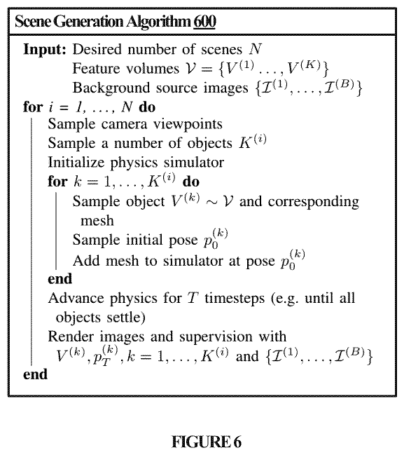

The operations of process 400 further include, in generation of the new scene(s), sampling a number of objects (step 415). Sampling the objects may include sampling some or all of the feature volumes extracted from the real scenes. However, sampling objects may further include sampling objects that may not have appeared in the same source scene. For example, objects may be sampled from previous source scenes that the NeRF model has encountered. The operations of process 400 further include posing the objects in the new scene(s) (step 420). In some examples, a physics simulator (e.g., Mujoco) is used to pose the objects in geometrically realistic configurations in the new scene. The operations of process 400 further include rendering the composed scenes (step 425). Once the objects to be included in the synthetic scene are sampled and posed, COV-NeRF renders the composed scenes, which may include an RGB image, a depth map, a segmentation mask, and the like. The process is further described in reference to the scene generation algorithm of FIG. 6.

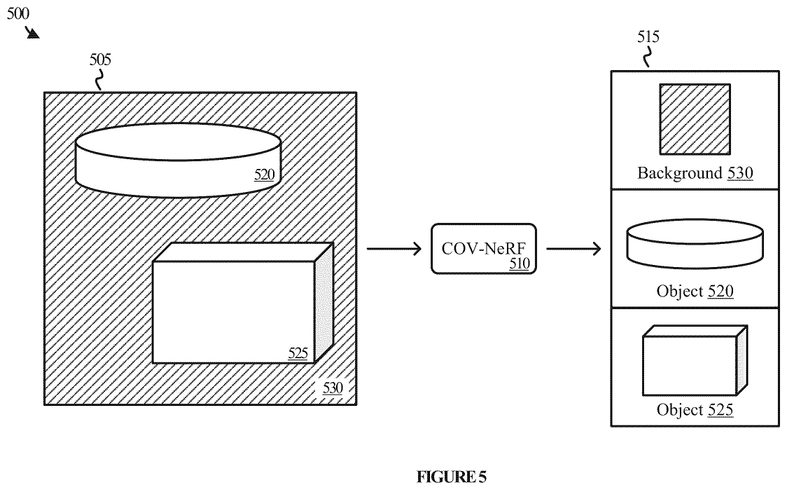

FIG. 5 illustrates scene decomposition example 500. Scene decomposition example 500 gives an exemplary illustration of COV-NeRF scene decomposition capabilities. As previously described, COV-NeRF can extract neural object representations from disparate source scenes and compose the objects into new scenes in different quantities, poses, and sizes, and render both photorealistic images and the corresponding supervision for many perception tasks. Thus, a key part of COV-NeRF is its object-composable nature.

Scene decomposition example 500 includes scene 505, COV-NeRF 510, and decomposition 515. Scene 505 may be representative of an image from real images 115, source image 305, and/or source image 310 from the preceding Figures. COV-NeRF 510 may be representative of COV-NeRF model 120 from the preceding Figures. COV-NeRF 510 runs on a computing system as previously described. Scene 505 includes object 520, object 525, and background 530. COV-NeRF 510 decomposes scene 505 into decomposition 515. Decomposition 515 includes a decomposed version of scene 505, in which background 530, object 520, and object 525 are each represented independently from the other elements from the scene.

FIG. 6 illustrates scene generation algorithm 600. Scene generation algorithm is an example of an algorithm employed by a trained COV-NeRF model (e.g., COV-NeRF model 120) to procedurally generate new scenes based on a set of input images (e.g., real images 115, source image 305, and/or source image 310). Scene generation algorithm 600 is provided only for purposes of example. A NeRF model in accordance with the teachings herein may employ a different algorithm that is still contemplated by the present disclosure.

In accordance with scene generation algorithm 600, given the collection of real scenes (e.g., real images 115) the COV-NeRF model extracts the feature volumes and meshes for each unoccluded object in the images. The meshes are obtained by running Marching Cubes on the voxel occupancy predictions. Objects (which may or may not have appeared in the same source scene) are then sampled by the model and a physics simulator (e.g., Mujoco) is used to pose the objects in geometrically realistic configurations. COV-NeRF model 120 then renders the composed scenes (i.e., synthetic images 125).

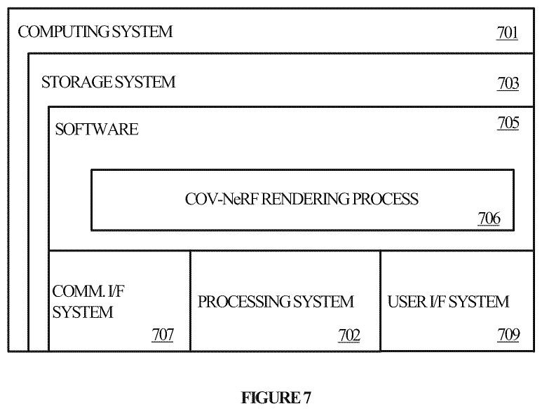

FIG. 7 illustrates computing system 701, which is representative of any system or collection of systems in which the various processes, programs, services, and scenarios disclosed herein may be implemented. Examples of computing system 701 include, but are not limited to, desktop computers, laptop computers, mobile computers, server computers, routers, web servers, cloud computing platforms, and data center equipment, as well as any other type of physical or virtual server machine, container, and any variation or combination thereof.

Computing system 701 may be implemented as a single apparatus, system, or device or may be implemented in a distributed manner as multiple apparatuses, systems, or devices. Computing system 701 includes, but is not limited to, processing system 702, storage system 703, software 705, communication interface system 707, and user interface system 709. Processing system 702 is operatively coupled with storage system 703, communication interface system 707, and user interface system 709. Components of computing system 701 may be optional or excluded in certain implementations.

Processing system 702 loads and executes software 705 from storage system 703. Software 705 includes and implements COV-NeRF rendering process 706, which may be representative of any or all of the scene rendering, model training, and perception processes discussed with respect to the preceding Figures, such as process 200 and process 400. When executed by processing system 702, software 705 directs processing system 702 to operate as described herein for at least the various processes, operational scenarios, and sequences discussed in the foregoing implementations. Computing system 701 may optionally include additional devices, features, or functionality not discussed for purposes of brevity.

Referring still to FIG. 7, processing system 702 may comprise a microprocessor and other circuitry that retrieves and executes software 705 from storage system 703. Processing system 702 may be implemented within a single processing device but may also be distributed across multiple processing devices or sub-systems that cooperate in executing program instructions. Examples of processing system 702 include general purpose central processing units, graphical processing units, application specific processors, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements, such as a controller, capable of communicating with processing system 702 or possibly other systems.

Software 705 (including COV-NeRF rendering process 706) may be implemented in program instructions and among other functions may, when executed by processing system 702, direct processing system 702 to operate as described with respect to the various operational scenarios, sequences, and processes illustrated herein. For example, software 705 may include program instructions for implementing the scene rendering, model training, and/or perception processes described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtualization software, or other application software. Software 705 may also comprise firmware or some other form of machine-readable processing instructions executable by processing system 702.

In general, software 705 may, when loaded into processing system 702 and executed, transform a suitable apparatus, system, or device (of which computing system 701 is representative) overall from a general-purpose computing system into a special-purpose computing system customized to perform the various processes described herein. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary, etc.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The above description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described herein can be combined in various ways to form multiple variations of the invention. As a result, the invention is not limited to the specific examples described herein, but only by the claims and their equivalents.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology and may be included in more than one implementation. In addition, such phrases do not necessarily refer to the same embodiments or different embodiments.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents. The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method comprising:
generating a synthetic dataset using a Neural Radiance Field (NeRF) model, wherein the NeRF model:
receives as input a real image of a real scene, wherein the real image comprises at least a plurality of objects and a background;
extracts, from the real image, a feature volume for each object of the plurality of objects; and
renders one or more synthetic scenes of the synthetic dataset, wherein each scene of the synthetic scenes comprises at least one rendered synthetic object having a pose that differs in other scenes of the one or more synthetic scenes;
training a perception model based at least in part on the synthetic dataset including the one or more synthetic scenes; and
controlling a robotic system based at least in part on output from the perception model that has been trained on the synthetic dataset.

2. The method of claim 1, wherein the NeRF model, prior to extracting the feature volume for each object of the plurality of objects, decomposes the real scene into the plurality of objects and the background.

3. The method of claim 1, wherein the NeRF model generates the feature volume for each object of the plurality of objects from learned feature vectors specific to each object of the plurality of objects.

4. The method of claim 1, further comprising training the NeRF model with one or more real images and one or more synthetic images.

5. The method of claim 1, wherein the perception model comprises at least one of: a modal instance segmentation model and an amodal instance segmentation model.

6. The method of claim 1, wherein the perception model is a depth estimation model.

7. The method of claim 1, wherein:
the robotic system comprises a robotic arm; and
controlling the controlling the robotic system comprises controlling the robotic arm to pick up one or more items from a first location and move the one or more items to a second location.

8. One or more non-transitory computer-readable storage media having program instructions stored thereon, wherein the program instructions, when executed by a computing system, direct the computing system to perform operations, the operations comprising:
generating a synthetic dataset using a Neural Radiance Field (NeRF) model, wherein the NeRF model:
receives as input a real image of a real scene, wherein the real image comprises at least a plurality of objects and a background;
extracts, from the real image, a feature volume for each object of the plurality of objects; and
renders one or more synthetic scenes of the synthetic dataset, wherein each scene of the synthetic scenes comprises at least one rendered synthetic object having a pose that differs in other scenes of the one or more synthetic scenes;
training a perception model based at least in part on the synthetic dataset including the one or more synthetic scenes; and
controlling a robotic system based at least in part on output from the perception model that has been trained on the synthetic dataset.

9. The one or more non-transitory computer-readable storage media of claim 8, wherein the NeRF model, prior to extracting the feature volume for each object of the plurality of objects, decomposes the real scene into the plurality of objects and the background.

10. The one or more non-transitory computer-readable storage media of claim 8, wherein the NeRF model generates the feature volume for each object of the plurality of objects from learned feature vectors specific to each object of the plurality of objects.

11. The one or more non-transitory computer-readable storage media of claim 8, further comprising training the NeRF model with one or more real images and one or more synthetic images.

12. The one or more non-transitory computer-readable storage media of claim 8, wherein the perception model comprises at least one of: a modal instance segmentation model and an amodal instance segmentation model.

13. The one or more non-transitory computer-readable storage media of claim 8, wherein the perception model is a depth estimation model.

14. The one or more non-transitory computer-readable storage media of claim 8, wherein:
the robotic system comprises a robotic arm; and
controlling the controlling the robotic system comprises controlling the robotic arm to pick up one or more items from a first location and move the one or more items to a second location.

15. A system comprising:
one or more computer-readable storage media;
a processing system operatively coupled with the one or more computer-readable storage media; and
program instructions stored on the one or more computer-readable storage media, wherein the program instructions, when read and executed by the processing system, direct the processing system to at least:
generate a synthetic dataset using a Neural Radiance Field (NeRF) model, wherein the NeRF model:
receives as input a real image of a real scene, wherein the real image comprises at least a plurality of objects and a background;
extracts, from the real image, a feature volume for each object of the plurality of objects; and
renders one or more synthetic scenes of the synthetic dataset, wherein each scene of the synthetic scenes comprises at least one rendered synthetic object having a pose that differs in other scenes of the one or more synthetic scenes;
train a perception model based at least in part on the synthetic dataset including the one or more synthetic scenes; and
control a robotic system based at least in part on output from the perception model that has been trained on the synthetic dataset.

16. The system of claim 15, wherein the NeRF model, prior to extracting the feature volume for each object of the plurality of objects, decomposes the real scene into the plurality of objects and the background.

17. The system of claim 15, wherein the NeRF model generates the feature volume for each object of the plurality of objects from learned feature vectors specific to each object of the plurality of objects.

18. The system of claim 15, further comprising training the NeRF model with one or more real images and one or more synthetic images.

19. The system of claim 15, wherein the perception model comprises at least one of: a modal instance segmentation model and an amodal instance segmentation model.

20. The system of claim 15, wherein the perception model is a depth estimation model.
